(19) United States
(12) Patent Application Publication
(10) Pub. No.: US 2026/0342485 A1
(43) Pub. Date: Oct. 29, 2026

(54) HARQ DEVICE,COMMUNICATION DEVICE, AND PROCESSING METHOD IN HARQ DEVICE

(71) Applicant: Sharp Semiconductor Innovation Corporation, Tenri City (JP)

(72) Inventor: Seiichi HAMA, Tenri City (JP)

(21) Appl. No.: 19/433,272

(22) Filed: Dec. 26, 2025

(30) Foreign Application Priority Data
Apr. 25, 2025 (JP) 2025-073688

(51) Int. Cl. H04L 1/1812

(52) U.S. Cl. CPC H04L 1/1812

(57) ABSTRACT

A HARQ device includes: a buffer section configured to temporarily store a first LLR and a second LLR in a memory, the first LLR and the second LLR are included in an LLR sequence obtained by demodulating an externally fed modulated signal, the modulated signal being generated by modulating a bit sequence into a single symbol, the first LLR corresponds to a first bit included in the bit sequence, the second LLR corresponds to a second bit included in the bit sequence; and a reconstruction section configured to reconstruct the LLR sequence by using the first LLR and the second LLR both retrieved from the buffer section.

### CROSS-REFERENCE TO RELATED APPLICATION

The present application claims priority from Japanese Application JP2025-73688, the content to which is hereby incorporated by reference into this application.

### BACKGROUND OF THE INVENTION

### 1. Field of the Invention

The present disclosure relates to a HARQ device for performing HARQ in a communication device, a communication device, and a processing method in a HARQ device.

### 2. Description of the Related Art

HARQ (Hybrid Automatic Repeat reQuest) is known as a technology for achieving highly reliable wireless communication. In HARQ, a communication device (receiving device) performs error correction on LLR (Log Likelihood Ratio) data that is received from another communication device (transmitting device) and then demodulated. If the error correction has failed, the receiving device requests retransmission from the transmitting device and performs error correction again by combining the LLR data received from the transmitting device and then demodulated with the LLR data for which the error correction has failed. Therefore, the receiving device includes a memory for temporarily storing the LLR data for which the error correction has failed.

### SUMMARY OF THE INVENTION

With advances in wireless communication technology, the data traffic per unit time is increasing. Accordingly, there is a need to increase the capacity of memory used to temporarily store LLR data. To address this issue, Marius Arvinte et al., “Deep Log-Likelihood Ratio Quantization,” 27th European Signal Processing Conference, Mar. 11, 2019, pp. 1-5, proposes a deep learning-based method for lossy compression and quantization of LLRs.

The present disclosure, in an aspect thereof, has an object to propose a new method of compressing an LLR sequence for temporary storage in a memory in HARQ.

To address this issue, the present disclosure, in one aspect thereof, is directed to a HARQ device including: a buffer section configured to temporarily store a first LLR and a second LLR in a memory, the first LLR and the second LLR are included in an LLR sequence obtained by demodulating an externally fed modulated signal, the modulated signal being generated by modulating a bit sequence into a single symbol, the first LLR corresponds to a first bit included in the bit sequence, the second LLR corresponds to a second bit included in the bit sequence; and a reconstruction section configured to reconstruct the LLR sequence by using the first LLR and the second LLR both retrieved from the buffer section.

The present disclosure, in another aspect thereof, is directed to a processing method in a HARQ device, the method including: a step of temporarily storing a first LLR and a second LLR in a memory, the first LLR and the second LLR are included in an LLR sequence obtained by demodulating an externally fed modulated signal, the modulated signal being generated by modulating a bit sequence into a single symbol, the first LLR corresponds to a first bit included in the bit sequence, the second LLR corresponds to a second bit included in the bit sequence; and a step of reconstructing the LLR sequence by using the temporarily stored first LLR and the temporarily stored second LLR.

The present disclosure, in an aspect thereof, enables compressing an LLR sequence for temporary storage in a memory in HARQ.

### BRIEF DESCRIPTION OF THE DRAWINGS

FIG. 1 is a schematic diagram of compression and reconstruction of an LLR sequence in an HARQ device for a communication system in accordance with an embodiment of the present disclosure.

FIG. 2 is a schematic block diagram of the communication system.

FIG. 3 is a block diagram of an analysis system used in a simulation to investigate the

### CHARACTERISTICS OF AN LLR SEQUENCE.

FIG. 4 is a pair of graphs, the top graph representing a relationship between LLR0 and LLR2 contained in an LLR sequence and the bottom graph representing a relationship between LLR0 and LLR4 contained in this LLR sequence.

FIG. 5 is a pair of graphs, the top graph representing a relationship between LLR1 and LLR3 contained in the LLR sequence and the bottom graph representing a relationship between LLR1 and LLR5 contained in the LLR sequence.

FIG. 6 is a schematic block diagram of a configuration of the HARQ device.

FIG. 7 is a schematic block diagram of a configuration of a HARQ device for a communication system in accordance with another embodiment of the present disclosure.

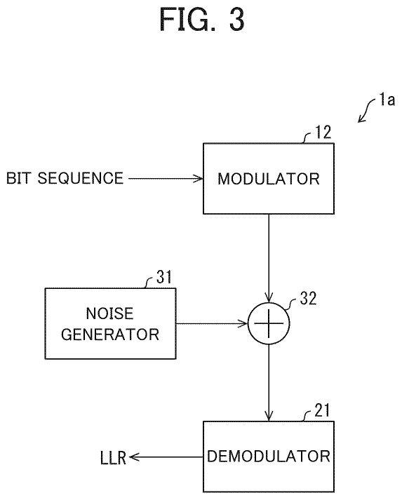

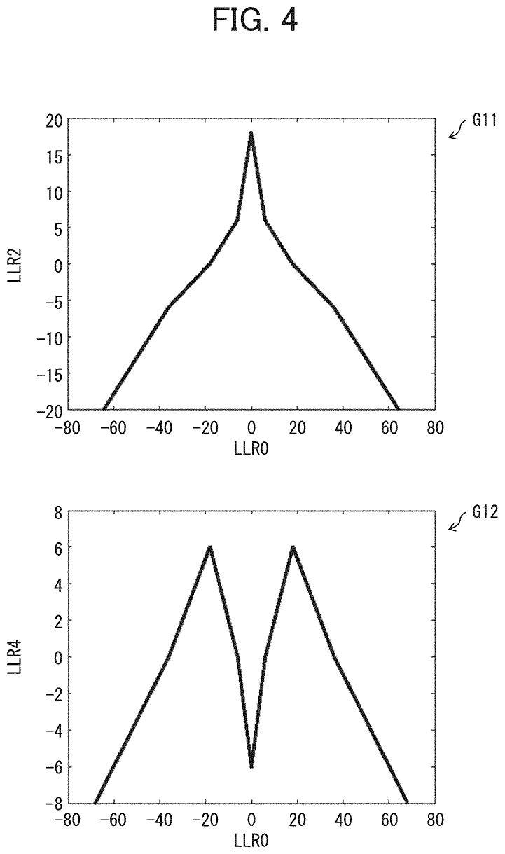

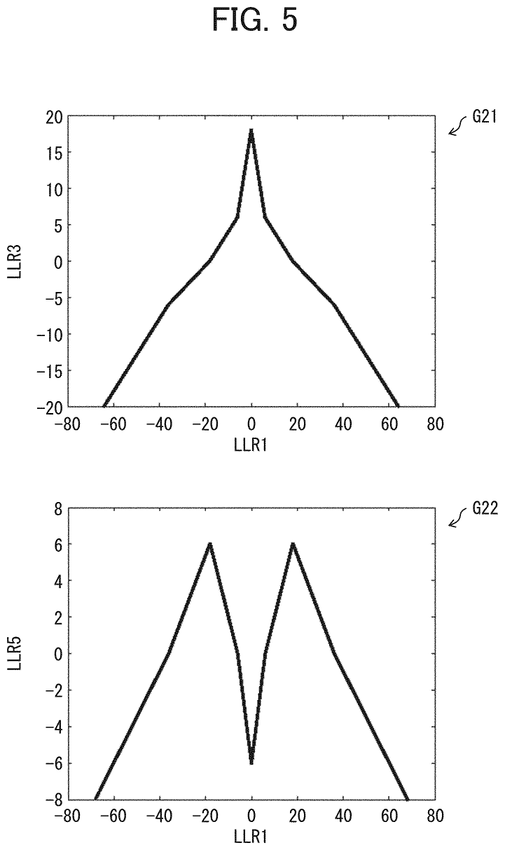

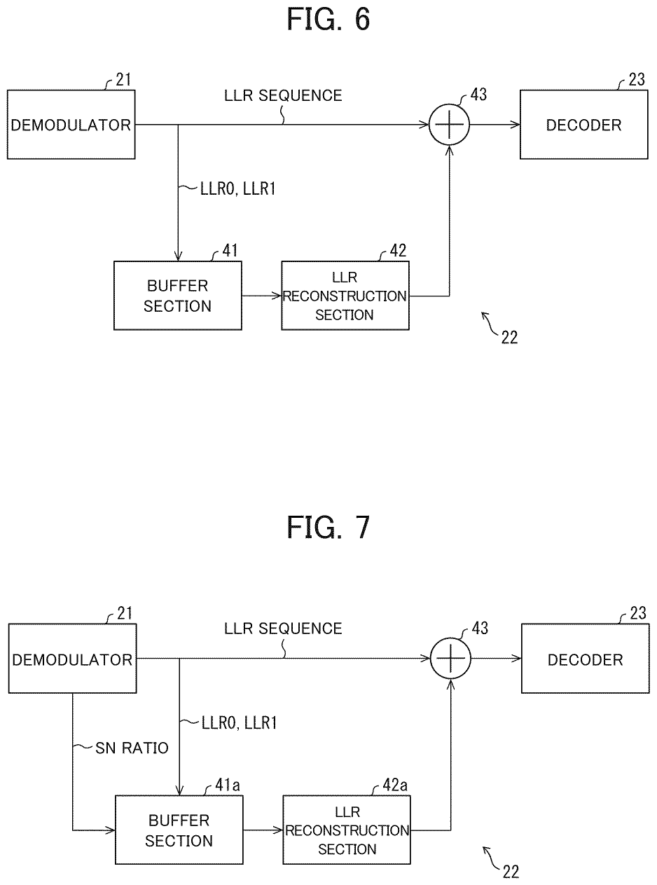

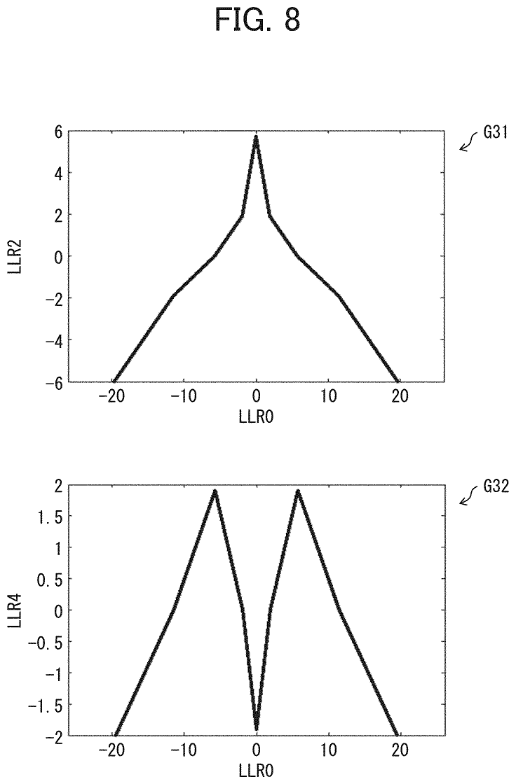

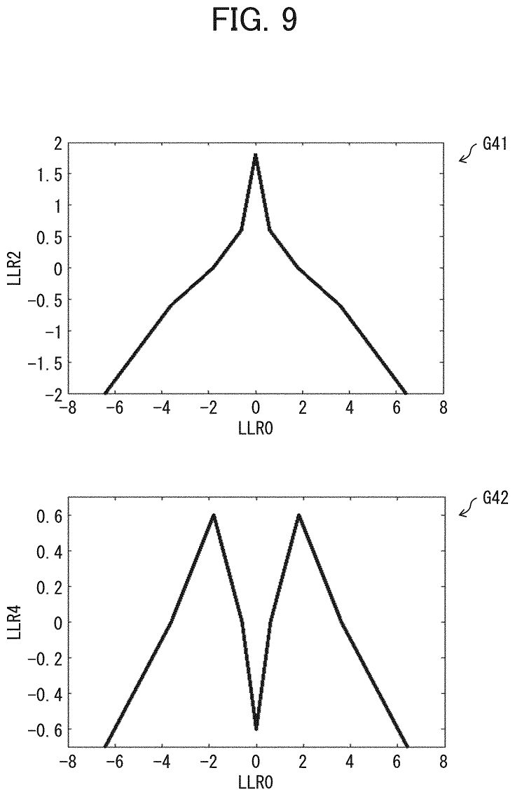

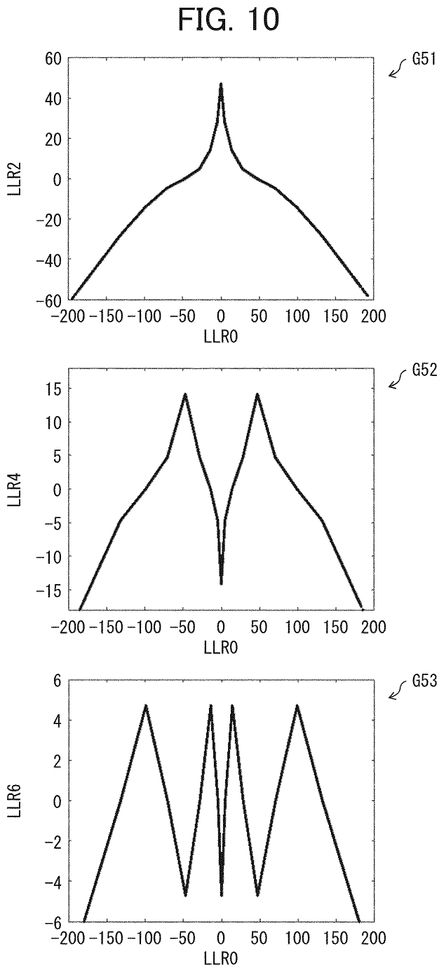

FIG. 8 is a pair of graphs representing a case in which the S/N ratio is specified to 10 dB in the analysis system shown in FIG. 3, wherein the top and bottom graphs in FIG. 8 correspond respectively to the top and bottom graphs in FIG. 4.

FIG. 9 is a parr of graphs representing a case in which the S/N ratio is specified to 5 dB in the analysis system shown in FIG. 3, wherein the top and bottom graphs in FIG. 9 correspond respectively to the top and bottom graphs in FIG. 4.

FIG. 10 is a graph corresponding to FIG. 4 and representing a case in which the communication system includes a modulator that operates by a 256 QAM modulation scheme.

### DETAILED DESCRIPTION OF THE INVENTION

The following will describe embodiments of the present disclosure in detail. Note that members of an embodiment that have the same function as members of another embodiment are denoted by the same reference numerals and description thereof may be omitted for convenience of description.

### Embodiment 1

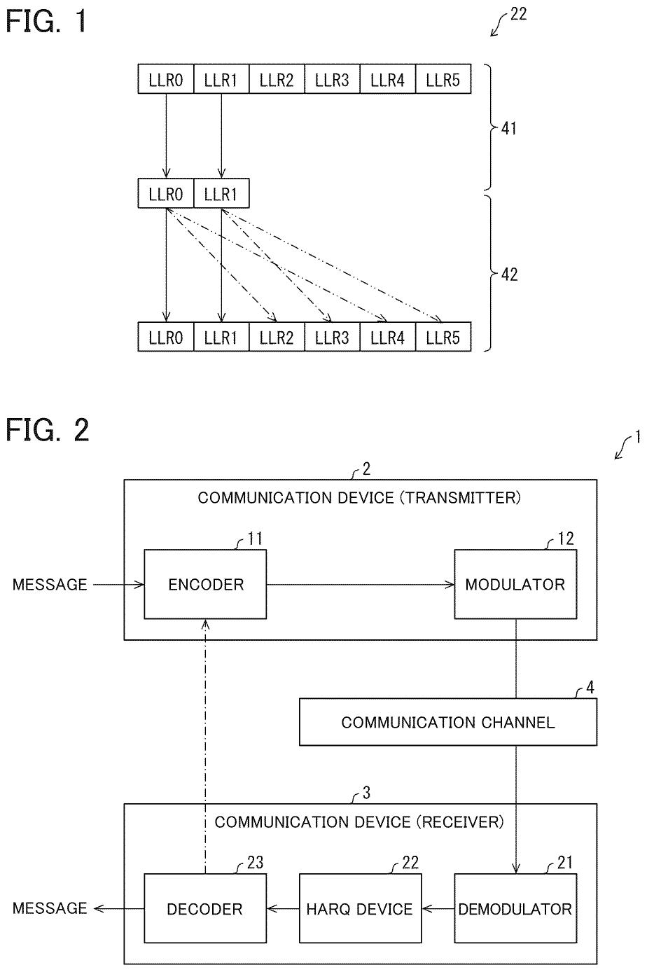

A description is now given of an embodiment of the present disclosure with reference to FIGS. 1 to 6.

### Communication System

FIG. 2 is a schematic block diagram of a communication system in accordance with the present embodiment. A communication system 1 in accordance with the present embodiment employs an error correcting code and HARQ to achieve high-quality and high-reliability communication.

Referring to FIG. 2, in the communication system 1 in accordance with the present embodiment, a communication device 2 for transmitting a message and a communication device 3 for receiving a message are configured to be communicable via a communication channel 4. Throughout the following description, the communication device 2 for transmitting a message will be referred to as the “transmitter 2,” and the communication device 3 for receiving a message will be referred to as the “receiver 3.”

### Transmitter

The transmitter 2 includes an encoder 11 and a modulator 12. The encoder 11 acquires a message and encodes the acquired message for error correction in the receiver 3. The encoding utilizes an encoding scheme such as LDPC (Low Density Parity Check) encoding, turbo encoding, or polar encoding. This encoding generates encoded data containing: an information bit sequence corresponding to the message; and a redundant bit sequence for error correction. The encoder 11 transfers part of the generated encoded data as transmission data to the modulator 12.

The modulator 12 performs digital modulation on the transmission data obtained from the encoder 11 to transport information via the communication channel 4. A modulation scheme such as QPSK (Quadrature Phase Shift Keying) or multilevel QAM (Quadrature Amplitude Modulation) is used in the digital modulation. The digital modulation generates a modulated signal corresponding to the transmission data. The modulator 12 transmits the generated modulated signal to the receiver 3 via the communication channel 4.

### Receiver

The receiver 3 includes a demodulator 21, a HARQ device 22, and a decoder 23. The demodulator 21 generates LLR data corresponding to the transmission data by demodulating the modulated signal by a demodulation scheme that corresponds to the modulation scheme. The demodulator 21 transfers the generated LLR data to the HARQ device 22.

The LLR data contains a plurality of LLRs corresponding respectively to a plurality of bits in the transmission data. An LLR is given by equation (1) below:

LLR=log{(Likelihood of Corresponding Bit Being 0)/(Likelihood of Corresponding Bit Being 1)} (1).

As can be understood from the equation (1), As the LLR increases from 0, the likelihood of the corresponding bit being 0 increases, while as the LLR decreases from 0, the likelihood of the corresponding bit being 1 increases. Therefore, as the LLR approaches 0, it becomes increasingly unclear whether the corresponding bit is 0 or 1, and when the LLR is equal to 0, it is totally unclear whether the corresponding bit is 0 or 1.

The HARQ device 22 receives the LLR data from the demodulator 21 to temporarily store the LLR data. This LLR data corresponds to part of the aforementioned encoded data. In addition, the HARQ device 22 generates decoding LLR data that is a combination of one or more pieces of the temporarily stored LLR data and the LLR data obtained from the demodulator 21 and transfers the generated decoding LLR data to the decoder 23.

The decoder 23 performs error correction and decoding on the decoding LLR data obtained from the HARQ device 22 by a decoding scheme that corresponds to the encoding scheme. If this error correction is successful, the decoder 23 outputs a decoded message, and the receiver 3 transmits an ACK (acknowledgment) to the transmitter 2 via the communication channel 4. In this case, the transmitter 2 repeats this process to transmit a new message to the receiver 3. On the other hand, if the error correction is not successful, the receiver 3 transmits a NACK (negative acknowledgment) to the transmitter 2, via the communication channel 4. In this case, the encoder 11 in the transmitter 2 transfers either untransmitted part of the encoded data or part thereof as transmission data to the modulator 12.

### Example of HARQ Process

A description is given of an exemplary HARQ process in the communication system 1 which is configured as above. This exemplary process is used in 5G NR. Note that the code rate R is ⅓ in the following example, and this description equally applies when the code rate R is not ⅓.

In the transmitter 2, the encoder 11 generates encoded data that has a bit length 3 times that of the information bit sequence that corresponds to the message. The encoded data increases with a decrease in the code rate in this manner.

The encoder 11 first generates looped encoded data by linking the start and end of the encoded data. Next, the encoder 11 generates first to fourth data segments from the looped encoded data. The first to fourth data segments have the same data length and have partial overlap between adjacent data segments. In addition, the entire encoded data is obtained by overlapping the first to fourth data segments.

In other words, an ending portion of the first data segment overlaps a starting portion of the second data segment. In addition, an ending portion of the second data segment overlaps a starting portion of the third data segment. In addition, an ending portion of the third data segment overlaps a starting portion of the fourth data segment. Then, an ending portion of the fourth data segment overlaps a starting portion of the first data segment.

Furthermore, the start of the first data segment is the same as the start of the encoded data. Therefore, the first data segment contains the information bit sequence and a part of the redundant bit sequence of the encoded data.

The encoder 11 in the transmitter 2 first transfers the first data segment of the encoded data as transmission data to the modulator 12. In this case, the LLR data that the HARQ device 22 in the receiver 3 receives from the demodulator 21 is first LLR data that corresponds to the first data segment. The HARQ device 22 temporarily stores the first LLR data and transfers the first LLR data as decoding LLR data to the decoder 23. The decoder 23 outputs a decoded message upon a successful error correction of the decoding LLR data.

On the other hand, if the decoder 23 in the receiver 3 fails in the error correction of the decoding LLR data, the encoder 11 in the transmitter 2 transfers the third data segment of the encoded data as transmission data to the modulator 12. In this case, the LLR data that the HARQ device 22 in the receiver 3 receives from the demodulator 21 is third LLR data that corresponds to the third data segment. The HARQ device 22 further temporarily stores the third LLR data obtained from the demodulator 21 and combines the first LLR data for which error correction has failed with the third LLR data and transfers the resultant combination as decoding LLR data to the decoder 23. If the error correction of the decoding LLR data is successful, the decoder 23 outputs a decoded message.

On the other hand, if the decoder 23 in the receiver 3 fails in the error correction of the decoding LLR data, the encoder 11 in the transmitter 2 transfers the fourth data segment of the encoded data as transmission data to the modulator 12. In this case, the LLR data that the HARQ device 22 in the receiver 3 receives from the demodulator 21 is fourth LLR data that corresponds to the fourth data segment. The HARQ device 22 further temporarily stores the fourth LLR data obtained from the demodulator 21 and combines the first LLR data and the third LLR data for which error correction has failed with the fourth LLR data and transfers the resultant combination as decoding LLR data to the decoder 23. If the error correction of the decoding LLR data is successful, the decoder 23 outputs a decoded message.

On the other hand, if the decoder 23 in the receiver 3 fails in the error correction of the decoding LLR data, the encoder 11 in the transmitter 2 transfers the second data segment of the encoded data as transmission data to the modulator 12. In this case, the LLR data that the HARQ device 22 in the receiver 3 receives from the demodulator 21 is second LLR data that corresponds to the second data segment. The HARQ device 22 combines the first LLR data, the third LLR data, and the fourth LLR data for which error correction has failed with the second LLR data and transfers the resultant combination as decoding LLR data to the decoder 23. If the error correction of the decoding LLR data is successful, the decoder 23 outputs a decoded message.

On the other hand, if the decoder 23 fails again in the error correction, the transmitter 2 and the receiver 3 determine that the transmission of the message has failed. Then, the encoded data in the encoder 11, as well as the first LLR data, the third LLR data, and the fourth LLR data temporarily stored in the HARQ device 22, are discarded.

### LLR Sequence Analysis

A simulation was carried out to investigate the characteristics of an LLR sequence contained in LLR data.

FIG. 3 is a block diagram of an analysis system used in the simulation. An analysis system 1a shown in FIG. 3 includes the modulator 12 and the demodulator 21, both shown in FIG. 2, and further includes a noise generator 31 and an adder 32.

The noise generator 31 generates a noise signal for output to the adder 32. The noise signal may be, for example, additive white gaussian noise (Additive white Gaussian noise, AWGN). The adder 32 adds the modulated signal from the modulator 12 and the noise signal from the noise generator 31 for output to the demodulator 21. The noise generator 31 and the adder 32 are provided to simulate the addition of noise signals onto the modulated signal in the communication channel 4 shown in FIG. 2.

In the analysis system 1a configured as above, a bit sequence generated using random numbers is modulated to a modulated signal in the modulator 12, the noise signal is added in the adder 32, and the result is demodulated to an LLR sequence in the demodulator 21.

In the simulation, the modulator 12 operates by a 64 QAM digital modulation scheme. The modulator 12, in 64 QAM, generates a modulated signal containing a single symbol obtained by modulating a 6-bit, bit sequence of b0 to b5. The demodulator 21 then generates an LLR sequence containing LLR0 to LLR5 that are LLRs corresponding respectively to bits b0 to b5.

In other words, LLR0=log{(likelihood of bit b0 being 0)/(likelihood of bit b0 being 1)}, and LLR1=log{(likelihood of bit b1 being 0)/(likelihood of bit b1 being 1)}. In addition, LLR2=log{(likelihood of bit b2 being 0)/(likelihood of bit b2 being 1)}, and LLR3=log{(likelihood of bit b3 being 0)/(likelihood of bit b3 being 1)}. Then, LLR4=log{(likelihood of bit b4 being 0)/(likelihood of bit b4 being 1)}, and LLR5=log{(likelihood of bit b5 being 0)/(likelihood of bit b5 being 1)}.

FIGS. 4 to 5 are pairs of graphs representing relationships among LLR0 to LLR5 in the LLR sequence generated in the simulation. Specifically, the top graph in FIG. 4 is a graph G11 representing a relationship between LLR0 and LLR2, and the bottom graph in FIG. 4 is a graph G12 representing a relationship between LLR0 and LLR4. In addition, the top graph in FIG. 5 is a graph G21 representing a relationship between LLR1 and LLR3, and the bottom graph in FIG. 5 is a graph G22 representing a relationship between LLR1 and LLR5. Note that in FIGS. 4 and 5, the S/N ratio (signal-to-noise ratio) of the modulated signal from the modulator 12 and the noise signal from the noise generator 31 is 15 dB.

From FIG. 4, it is understood that LLR2 corresponding to bit b2 and LLR4 corresponding to bit b4 are uniquely determined by LLR0 corresponding to bit b0 (first bit). In addition, from FIG. 5, it is understood that LLR3 corresponding to bit b3 and LLR5 corresponding to bit b5 are uniquely determined by LLR1 corresponding to bit b1 (second bit).

### Compression and Reconstruction of LLR Sequence

The compression and reconstruction of an LLR sequence in the HARQ device 22 in accordance with the present embodiment is based on results of the simulation above. Note that the following description assumes that the modulator 12 operates by a 64 QAM digital modulation scheme.

FIG. 1 is a schematic diagram of compression and reconstruction of an LLR sequence in the HARQ device 22. Referring to FIG. 1, to compress an LLR sequence, the HARQ device 22 temporarily stores LLR0 (first LLR) and LLR1 (second LLR) in the LLR sequence, but does not temporarily store remaining LLR2 to LLR5. In other words, the HARQ device 22 compresses the LLR sequence to generate LLR0 (first LLR) and LLR1 for temporary storage. Hence, the HARQ device 22 can reduce the size of the buffer for temporarily storing the LLRs.

To reconstruct the LLR sequence, the HARQ device 22 then generates LLR2 and LLR4 from temporarily stored LLR0 and generates LLR3 and LLR5 from temporarily stored LLR1. Hence, the HARQ device 22 can reconstruct the LLR sequence containing LLR0 to LLR5 from temporarily stored LLR0 and LLR1.

FIG. 6 is a schematic block diagram of a configuration of the HARQ device 22. Referring to FIG. 6, the HARQ device 22 includes a buffer section 41, an LLR reconstruction section 42 (reconstruction section), and an adder 43.

The buffer section 41 temporarily stores LLR0 and LLR1 in the LLR sequence obtained from the demodulator 21. The buffer section 41 may have any size capable of storing all LLR0s and LLR1s contained in the first LLR data, the third LLR data, and the fourth LLR data described above. The buffer section 41 preferably includes a controller and memory capable of high-speed operation and compliant with, for example, DDR SDRAM (Double-Data-Rate Synchronous Dynamic Random Access Memory) standards. In addition, the buffer section 41 may overwrite the temporarily stored data related to past messages with data related to the current message. Alternatively, upon confirming success or failure of transmission of a message, the buffer section 41 may erase the data related to the message.

The LLR reconstruction section 42 reconstructs the LLR sequence containing LLR0 to LLR5 by using LLR0 and LLR1 temporarily stored in the buffer section 41. The LLR reconstruction section 42 outputs the LLR data containing a plurality of reconstructed LLR sequences to the adder 43.

Specifically, the LLR reconstruction section 42 stores, in advance, a first correspondence table (first correspondence information) showing the correspondence between LLR0 and LLR2 as represented by the graph G11 in FIG. 4 and reconstructs LLR2 from this LLR0 by referring to the first correspondence table. In addition, the LLR reconstruction section 42 stores, in advance, a second correspondence table (second correspondence information) showing the correspondence between LLR0 and LLR4 as represented by the graph G12 in FIG. 4 and reconstructs LLR4 from this LLR0 by referring to the second correspondence table.

In addition, the LLR reconstruction section 42 stores, in advance, a third correspondence table showing the correspondence between LLR1 and LLR3 as represented by the graph G21 in FIG. 5 and reconstructs LLR3 from this LLR1 by referring to the third correspondence table. Then, the LLR reconstruction section 42 stores, in advance, a fourth correspondence table showing the correspondence between LLR0 and LLR2 as represented by the graph G22 in FIG. 5 and reconstructs LLR5 from this LLR1 by referring to the fourth correspondence table.

Note that it is understood that the graphs G11, G12, G21, and G22 in FIGS. 4 and 5 can be divided into a plurality of line segments. Therefore, the LLR reconstruction section 42 may divide the graph G11 in FIG. 4 into a plurality of line segments and store, in advance, first correspondence data (first correspondence information) by which the LLR0 portion for each line segment is associated with an equation representing that line segment, instead of the first correspondence table. Then, the LLR reconstruction section 42 may calculate LLR2 from temporarily stored LLR0 by using the first correspondence data.

Subsequently, the LLR reconstruction section 42 may, likewise, store, in advance, second correspondence data (second correspondence information) generated on the basis of the graph G12 in FIG. 4, instead of the second correspondence table, and calculate LLR4 from temporarily stored LLR0 by using the second correspondence data. In addition, the LLR reconstruction section 42 may store, in advance, third correspondence data generated on the basis of the graph G21 in FIG. 5, instead of the third correspondence table, and calculate LLR3 from temporarily stored LLR1 by using the third correspondence data. Then, the LLR reconstruction section 42 may store, in advance, fourth correspondence data generated on the basis of the graph G22 in FIG. 5, instead of the fourth correspondence table, and calculate LLR5 from temporarily stored LLR1 by using the fourth correspondence data.

The adder 32 adds the LLR data obtained from the demodulator 21 and the LLR data temporarily stored in the buffer section 41 and reconstructed by the LLR reconstruction section 42 for output to the decoder 23. Specifically, the adder 32 outputs the first LLR data per se to the decoder 23 if the adder 32 has acquired the first LLR data from the demodulator 21. Meanwhile, if the adder 32 has acquired the third LLR data from the demodulator 21, the adder 32 adds the first LLR data obtained from the LLR reconstruction section 42 to the third LLR data and outputs the result to the decoder 23.

Meanwhile, if the adder 32 has acquired the fourth LLR data from the demodulator 21, the adder 32 adds the first LLR data and the third LLR data obtained from the LLR reconstruction section 42 to the fourth LLR data and outputs the result to the decoder 23. Then, if the adder 32 has acquired the second LLR data from the demodulator 21, the adder 32 adds the first LLR data, the third LLR data, and the fourth LLR data obtained from the LLR reconstruction section 42 to the second LLR data and outputs the result to the decoder 23.

### Additional Remarks

Note that the graphs G11, G12, G21, and G22 in FIGS. 4 and 5 are symmetric with respect to line LLR=0. Accordingly, the first to fourth correspondence tables may omit those cases where LLR0 and LLR1 take negative values. This configuration can reduce the amount of data for storing the first to fourth correspondence tables by half. In addition, the LLR reconstruction section 42 can reconstruct LLR2 and LLR4 from the absolute value of LLR0 and reconstruct LLR3 and LLR5 from the absolute value of LLR1.

In addition, actual communication systems would include various devices such as a device for performing a descrambling process and a device for performing a delete matching process between the demodulator 21 and the decoder 23. In this case, the HARQ device 22 may further include these various devices. Then, the buffer section 41 may temporarily store LLR0 and LLR1 in the LLR sequence obtained from the demodulator 21, and the adder 43 may receive the LLR sequence reconstructed by the LLR reconstruction section 42 via the various devices.

### Embodiment 2

A description is given next of another embodiment of the present disclosure with reference to FIGS. 7 to 9.

FIG. 7 is a schematic block diagram of a configuration of a HARQ device 22 for a communication system 1 in accordance with the present embodiment. The HARQ device 22 shown in FIG. 7 differs from the HARQ device 22 shown in FIG. 6 in that the former includes a buffer section 41a in replace of the buffer section 41 and an LLR reconstruction section 42a in replace of the LLR reconstruction section 42, but has otherwise the same configuration as the HARQ device 22 shown in FIG. 6.

The top graph and the bottom graph in FIG. 8 are graphs G31 and G32 that correspond respectively to the top graph and the bottom graph in FIG. 4, both showing a case in which the S/N ratio is specified to 10 dB in the analysis system 1a shown in FIG. 3. In addition, the top graph and the bottom graph in FIG. 9 are graphs G41 and G42 that correspond respectively to the top graph and the bottom graph in FIG. 4, both showing a case in which the S/N ratio is specified to 5 dB in the analysis system 1a shown in FIG. 3.

From FIGS. 4, 8, and 9, it is understood that the shape of the curve does not change with the S/N ratio, but the scale of LLR0, LLR2, and LLR4 changes with the S/N ratio. For example, a comparison of the graph in FIG. 4 in which the S/N ratio is 15 dB and the graph in FIG. 9 in which the S/N ratio is 5 dB shows that if the S/N ratio increases by 10 dB, in other words, if the actual value of the S/N ratio increases by 10 fold, the scale of LLR0, LLR2, and LLR4 increases by 10 fold. In addition, this description equally applies to LLR1, LLR3, and LLR5.

Throughout the following, the actual value of the S/N ratio will be referred to as the “actual value of the S/N ratio,” whereas the S/N ratio in decibels will be referred to as the “decibel value of the S/N ratio.” The relationship between the decibel value of the S/N ratio and the actual value of the S/N ratio is given by equation (2) below:

(Decibel Value of S/N Ratio)=10×Log₁₀(Actual Value of S/N Ratio) (2).

Accordingly, in the communication system 1 in accordance with the present embodiment, the buffer section 41a temporarily stores LLR0 and LLR1 in the LLR sequence obtained from the demodulator 21 and acquires the actual value of the S/N ratio from the demodulator 21 for temporary storage. Note that to reduce the amount of data temporarily stored in the memory, the actual value of the S/N ratio may be common to a plurality of LLR sequences.

In addition, the reciprocal of actual value of the S/N ratio, the decibel value of the S/N ratio, or another one of various values related to the S/N ratio may be used instead of the actual value of the S/N ratio. In addition, the buffer section 41a may acquire the variance value of the modulated signal and the variance value of the noise from the demodulator 21 and calculate the actual value of the S/N ratio by using equation (3) below to temporarily store the actual value of the S/N ratio:

(Actual Value of S/N Ratio)=(Variance Value of Modulated Signal)/(Variance Value of Noise) (3).

The LLR reconstruction section 42a reconstructs the LLR sequence containing LLR0 to LLR5 by using LLR0 and LLR1 temporarily stored in the buffer section 41 as well as the actual value of the S/N ratio. The LLR reconstruction section 42a outputs the LLR data containing a plurality of reconstructed LLR sequences to the adder 43.

Specifically, the LLR reconstruction section 42a stores, in advance, a first correspondence table showing the correspondence between normalized nLLR0 obtained by dividing LLR0 shown in the graph G11 in FIG. 4 by the actual value of the S/N ratio and normalized nLLR2 obtained by dividing LLR2 shown in the graph G11 in FIG. 4 by the actual value of the S/N ratio. Next, the LLR reconstruction section 42 calculates nLLR0 by dividing LLR0 temporarily stored in the buffer section 41 by the actual value of the S/N ratio and acquires nLLR2 which corresponds to nLLR0 by referring to the first correspondence table. The LLR reconstruction section 42 then reconstructs LLR2 by multiplying nLLR2 by the actual value of the S/N ratio.

Subsequently, the LLR reconstruction section 42, likewise, reconstructs LLR4 from LLR0 and the actual value of the S/N ratio and reconstructs LLR3 and LLR5 from LLR1 and the actual value of the S/N ratio. In addition, this description equally applies when the graphs in FIGS. 4 and 5 are divided into a plurality of line segments.

### Variation Example

FIG. 10 is a graph corresponding to FIG. 4 and representing a case in which the modulator 12 operates by a 256 QAM modulation scheme. The modulator 12, in 256 QAM, generates a modulated signal containing a single symbol obtained by modulating an 8-bit, bit sequence of b0 to b7. The demodulator 21 then generates an LLR sequence containing LLR0 to LLR7 that are LLRs corresponding respectively to bit b0 to bit b7.

The top graph in FIG. 10 is a graph G51 representing a relationship between LLR0 and LLR2, the middle graph in FIG. 10 is a graph G52 representing a relationship between LLR0 and LLR4, and the bottom graph in FIG. 10 is a graph G53 representing a relationship between LLR0 and LLR6. From FIG. 10, it is understood that LLR2, LLR4, and LLR6 are uniquely determined by LLR0 even in 256 QAM. Note that this description equally applies to LLR1, LLR3, LLR5, and LLR7.

It is therefore understood that the HARQ device 22 can reconstruct the LLR sequence from LLR0 and LLR1 in any QAM if the HARQ device 22 temporarily stores LLR0 and LLR1 in the LLR sequence. In other words, the HARQ device 22 can reconstruct the LLR sequence by reconstructing the (2k+1)-th LLR (k is a natural number) from the first LLR and also reconstructing the (2k+2)-th LLR (k is a natural number) from the second LLR. Note that this description equally applies to modulation schemes other than QAM.

### Software Implementation

The HARQ device 22 (hereinafter, “device”) may be implemented by a program causing a computer to function as the device and causing a computer to function as the control blocks of the device (in particular, the LLR reconstruction section 42).

In such cases, the device includes a computer including at least one control device (e.g., a processor) and at least one storage device (e.g., a memory) as hardware for executing the program. The functions described in the embodiments above are implemented by the control and storage devices executing this program.

The program may be stored not temporarily, but in one or more computer-readable storage media. The storage medium/media may or may not be provided in the device. In the latter case, the program may be delivered to the device via any wired or wireless transmission medium.

Alternatively, the functions of the control blocks may be partially or entirely implemented by logic circuitry. For instance, the scope of the present disclosure encompasses integrated circuits including logic circuitry that functions as the control blocks. As another alternative, the functions of the control blocks may be implemented by, for example, a quantum computer.

In addition, the processes described in the embodiments may be implemented by AI (Artificial Intelligence). In such cases, the AI may operate on the control device or may operate on another device (e.g., an edge computer or a cloud server).

### General Description

A HARQ device 22 of aspect 1 of the present disclosure includes: a buffer section configured to temporarily store a first LLR and a second LLR in a memory, the first LLR and the second LLR are included in an LLR sequence obtained by demodulating an externally fed modulated signal, the modulated signal being generated by modulating a bit sequence into a single symbol, the first LLR corresponds to a first bit included in the bit sequence, the second LLR corresponds to a second bit included in the bit sequence; and a reconstruction section (LLR reconstruction section 42, 42a) configured to reconstruct the LLR sequence by using the first LLR and the second LLR both retrieved from the buffer section.

Since this configuration enables reconstructing the LLR sequence from the first LLR and the second LLR, only the first LLR and the second LLR in the LLR sequence need to be temporarily stored in the memory. Therefore, the LLR sequence can be compressed for temporary storage in the memory.

In aspect 2 of the present disclosure, the aforementioned HARQ device 22 of aspect 1 may be configured such that the buffer section further temporarily stores, in the memory, a value related to a S/N ratio of the modulated signal and that the reconstruction section reconstructs the LLR sequence by using the first LLR and the second LLR both retrieved from the buffer section and the value related to the S/N ratio. This configuration enables appropriately reconstructing the LLR sequence on the basis of the noise of the modulated signal.

In aspect 3 of the present disclosure, the aforementioned HARQ device 22 of aspect 2 may be configured such that the buffer section stores the value related to the S/N ratio in association with a plurality of the first LLRs and a plurality of the second LLRs. This configuration enables reducing the amount of data temporarily stored in the memory in relation to the value related to the S/N ratio.

In aspect 4 of the present disclosure, the aforementioned HARQ device 22 of aspect 1 may be configured such that the reconstruction section contains, in advance, first correspondence information representing correspondence between the first LLR and a (2k+1)-th LLR (k is a natural number) in the LLR sequence and second correspondence information representing correspondence between the second LLR and a (2k+2)-th LLR (k is a natural number) in the LLR sequence, to reconstruct the LLR sequence from the first LLR and the second LLR by using the first correspondence information and the second correspondence information. This configuration enables readily reconstructing the LLR sequence.

In aspect 5 of the present disclosure, the aforementioned HARQ device 22 of aspect 1 may be configured such that the modulated signal is generated by quadrature amplitude modulation.

A communication device 3 of aspect 6 of the present disclosure is a communication device configured to perform HARQ, the communication device including: a demodulator 21 configured to generate an LLR sequence by demodulating a modulated signal generated by another communication device modulating a bit sequence to a single symbol and then transmitted from the other communication device; the HARQ device 22 of any one of aspects 1 to 5 configured to temporarily store LLR data including a plurality of the LLR sequences obtained from the demodulator and to generate decoding LLR data that is a combination of one or more pieces of the temporarily stored LLR data and LLR data obtained from the demodulator; and a decoder 23 configured to perform error correction and decoding on the decoding LLR data obtained from the HARQ device. This configuration achieves advantages similar to those achieved by aspects 1 to 5.

A processing method of aspect 7 of the present disclosure is a processing method in a HARQ device 22, the processing method including: a step of temporarily storing a first LLR and a second LLR in a memory, the first LLR and the second LLR are included in an LLR sequence obtained by demodulating an externally fed modulated signal, the modulated signal being generated by modulating a bit sequence into a single symbol, the first LLR corresponds to a first bit included in the bit sequence, the second LLR corresponds to a second bit included in the bit sequence; and a step of reconstructing the LLR sequence by using the temporarily stored first LLR and the temporarily stored second LLR.

This method achieves advantages similar to those achieved by aspect 1 above.

The HARQ device 22 of each aspect of the present disclosure may be implemented on a computer, in which case the computer is controlled so as to serve as the various sections (software elements) in the HARQ device 22. The present disclosure hence encompasses a control program for the HARQ device 22 causing the computer to implement the HARQ device 22 and also encompasses a computer-readable storage medium containing the control program.

The present disclosure is not limited to the description of the embodiments above and may be altered within the scope of the claims. Embodiments based on a proper combination of technical means disclosed in different embodiments are also encompassed in the technical scope of the present disclosure. Furthermore, new technical features can be created by combining different technical means disclosed in the embodiments.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A HARQ device comprising:
a buffer section configured to temporarily store a first LLR and a second LLR in a memory, the first LLR and the second LLR are included in an LLR sequence obtained by demodulating an externally fed modulated signal, the modulated signal being generated by modulating a bit sequence into a single symbol, the first LLR corresponds to a first bit included in the bit sequence, the second LLR corresponds to a second bit included in the bit sequence; and
a reconstruction section configured to reconstruct the LLR sequence by using the first LLR and the second LLR both retrieved from the buffer section.

2. The HARQ device according to claim 1, wherein
the buffer section further temporarily stores, in the memory, a value related to a S/N ratio of the modulated signal, and
the reconstruction section reconstructs the LLR sequence by using the first LLR and the second LLR both retrieved from the buffer section and the value related to the S/N ratio.

3. The HARQ device according to claim 2, wherein the buffer section stores the value related to the S/N ratio in association with a plurality of the first LLRs and a plurality of the second LLRs.

4. The HARQ device according to claim 1, wherein the reconstruction section contains, in advance, first correspondence information representing correspondence between the first LLR and a (2k+1)-th LLR (k is a natural number) in the LLR sequence and second correspondence information representing correspondence between the second LLR and a (2k+2)-th LLR (k is a natural number) in the LLR sequence, to reconstruct the LLR sequence from the first LLR and the second LLR by using the first correspondence information and the second correspondence information.

5. The HARQ device according to claim 1, wherein the modulated signal is generated by quadrature amplitude modulation.

6. A communication device configured to perform HARQ, the communication device comprising:
a demodulator configured to generate an LLR sequence by demodulating a modulated signal generated by another communication device modulating a bit sequence to a single symbol and then transmitted from the other communication device;
the HARQ device according to any one of claims 1 to 5 configured to temporarily store LLR data including a plurality of the LLR sequences obtained from the demodulator and to generate decoding LLR data that is a combination of one or more pieces of the temporarily stored LLR data and LLR data obtained from the demodulator; and
a decoder configured to perform error correction and decoding on the decoding LLR data obtained from the HARQ device.

7. A processing method in a HARQ device, the processing method comprising:
a step of temporarily storing a first LLR and a second LLR in a memory, the first LLR and the second LLR are included in an LLR sequence obtained by demodulating an externally fed modulated signal, the modulated signal being generated by modulating a bit sequence into a single symbol, the first LLR corresponds to a first bit included in the bit sequence, the second LLR corresponds to a second bit included in the bit sequence; and
a step of reconstructing the LLR sequence by using the temporarily stored first LLR and the temporarily stored second LLR.
